(19) United States
(12) Patent Application Publication
(10) Pub. No.: US 2019/0362106 A1
(43) Pub. Date: Nov. 28, 2019

(54) INFORMATION PROCESSING APPARATUS, INFORMATION PROCESSING METHOD, AND COMPUTER PROGRAM PRODUCT

(71) Applicant: FUJITSU CLIENT COMPUTING LIMITED, Kanagawa (JP)

(72) Inventor: Yoshie Shimazaki, Kawasaki (JP)

(73) Assignee: FUJITSU CLIENT COMPUTING LIMITED, Kanagawa (JP)

(21) Appl. No.: 16/534,156

(22) Filed: Aug. 7, 2019

Related U.S. Application Data
(63) Continuation of application No. PCT/JP2018/002933, filed on Jan. 30, 2018.

(30) Foreign Application Priority Data
Mar. 28, 2017 (JP) 2017-062958

(51) Int. Cl. G06F 21/84; G06F 21/31; G06F 21/62

(52) U.S. Cl. CPC G06F 21/84; G06F 21/6209; G06F 21/31

(57) ABSTRACT

An information processing apparatus includes: a memory; and a processor that is connected to the memory and that receives, from another information processing apparatus, an output request of a file and permits the information processing apparatus to output the file to an output device when the request source has the output right with respect to the file. The information processing apparatus has no output right with respect to the file and the output request includes information that specifies a request source of the output request.

### CROSS-REFERENCE TO RELATED APPLICATIONS

This application is national stage application of International Application No. PCT/JP2018/002933, filed Jan. 30, 2018, which designates the United States, incorporated herein by reference, and which claims the benefit of priority from Japanese Patent Application No. 2017-062958, filed Mar. 28, 2017, the entire contents of which are incorporated herein by reference.

### TECHNICAL FIELD

The present disclosure relates to an information processing apparatus, an information processing method, and a computer program product.

### BACKGROUND

In a class or the like using video, a system has been used, in which a presentation apparatus outputs the video to a display device such as a projector. The presentation apparatus outputs the video to the display device by streaming, for example.

In the streaming, the video is played back while video data is transmitted. Thus, if the transmission of the video data to the presentation apparatus is delayed, the video displayed on the display device may be disturbed or stopped, so that the playback quality of the video may deteriorate. One example of the technique to reduce influence due to the transmission delay is edge computing. In the edge computing, a video file is transmitted in advance from a transmission source device to the presentation apparatus. The presentation apparatus plays back the video file that has been received. In a video playback method, such as the edge computing in which the video file is transmitted to the presentation apparatus in advance, the deterioration of the playback quality of the video due to the transmission delay can be suppressed.

In order to protect the copyright of a maker or keep the confidentiality, a right to access to a file including content, such as video data and audio data, may be restricted. Examples of the restriction of the right include a case where an output right to a file is limited to right information such as a user account of the transmission source device. By restricting the right as described above, the output of the file by a third party is restricted, so that the security of the file can be kept. However, while the presence or absence of the output right to the file is determined based on the right information of the transmission source device, the presentation apparatus does not have the right to output the file. As a result, it may occur that the file that has been received from the transmission source device cannot be output with the right of the presentation apparatus.

### SUMMARY

One aspect of the disclosed technique is exemplified by the following information processing apparatus. The information processing apparatus includes a memory and a processor. The processor receives, from another apparatus, an output request of a file to which the apparatus has no output right. The output request includes information that specifies a request source of the output request. The processor permits the apparatus to output the file to an output device when the request source has an output right to the file.

### BRIEF DESCRIPTION OF THE DRAWINGS

FIG. 1 is a diagram that illustrates one example of a video display system including a presentation apparatus according to an embodiment;

FIG. 2 is a diagram that illustrates one example of a hardware structure of the presentation apparatus;

FIG. 3 is a diagram that illustrates one example of a hardware structure of a terminal;

FIG. 4 is a diagram that illustrates one example of a structure of a video file;

FIG. 5 is a diagram that illustrates one example of a scene where the video file is transmitted from the terminal to the presentation apparatus;

FIG. 6 is a diagram that illustrates one example of a case where the video file cannot be played back for want of an access right;

FIG. 7 is a diagram that illustrates one example of a process flow of a process in which the terminal transmits the video file to the presentation apparatus;

FIG. 8 is a diagram that illustrates one example of a process flow of a process in which the presentation apparatus plays back the video file;

FIG. 9 is a diagram that illustrates one example of an access right table that stores therein a list of access rights;

FIG. 10 is a diagram that illustrates one example of a transition of the access right to the video file in a case where a process in OP4 in FIG. 8 is branched to NO;

FIG. 11 is a diagram that illustrates one example of a transition of the access right to the video file in a process in OP5 in FIG. 8:

FIG. 12 is a diagram that illustrates one example of a process flow of a process in which the terminal transmits a playback end command;

FIG. 13 is a diagram that illustrates one example of a process flow of a process in which the presentation apparatus ends the playback of the video file;

FIG. 14 is a diagram that illustrates one example of a transition of the access right to the video file in a process in OP13 in FIG. 13; and

FIG. 15 is a diagram that illustrates one example of a relation between the access right for each user account and the video file using a pointer.

### DETAILED DESCRIPTION

An embodiment is hereinafter described with reference to the drawings. A structure of the embodiment to be described below is one example, and the technique disclosed herein is not limited to the structure of the embodiment.

### Embodiment

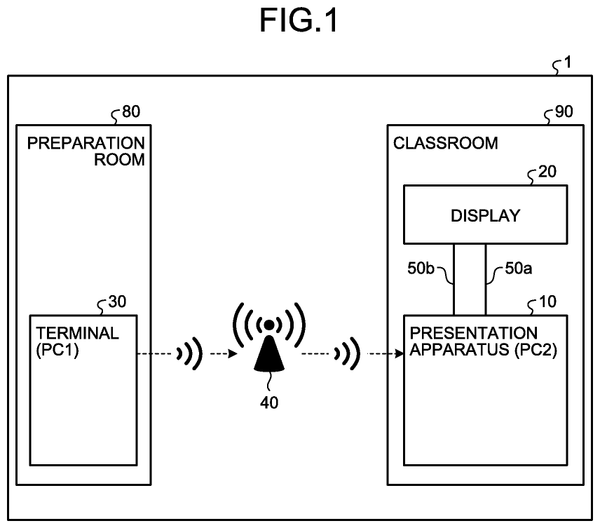

In the embodiment, a presentation apparatus that displays a received video is described as one example. FIG. 1 is a diagram that illustrates one example of a video display system 1 including the presentation apparatus according to the embodiment. In the video display system 1, a teaching material is stored in a terminal 30 that is disposed in a preparation room 80. The teaching material is, for example, a video file that is used as the teaching material. The video file is transmitted from the terminal 30 to a presentation apparatus 10, which is disposed in a classroom 90, through an access point 40. In the classroom 90, when a class is conducted, the video file that has been received by the presentation apparatus 10 is output to a display 20. The video display system 1 will be explained with reference to FIG. 1.

The video display system 1 includes the presentation apparatus 10, the display 20, the terminal 30, and the access point 40. The presentation apparatus 10 and the display 20 are connected by a video signal cable 50a for transmitting video signals and an audio signal cable 50b for transmitting audio signals.

The access point 40 is an access point that relays communication in a wireless local area network (LAN). In the wireless LAN, radio waves are transmitted and received to perform the wireless communication. The presentation apparatus 10 and the terminal 30 are able to wirelessly communicate with each other via the access point 40.

In the preparation room 80, the teaching material used in the class is prepared. The terminal 30 is an information processing apparatus that is disposed in the preparation room 80. The terminal 30 stores therein, for example, the video file that is used as the teaching material. An access right is set for the video file, and the video file can be played back with authority of a user account, to which the access right is given, for playing back the video file. The access right may be referred to as permission. The terminal 30 transmits the video file to the presentation apparatus 10 through the access point 40. In the embodiment, the host name given to the terminal 30 is “PC1”.

In the classroom 90, the video file is played back, and the class in which the played back video is used is conducted. The presentation apparatus 10 is an information processing apparatus that is disposed in the classroom 90. The presentation apparatus 10 receives the video file that is transmitted from the terminal 30 through the access point 40. The presentation apparatus 10 outputs the received video file to the display 20 in accordance with an instruction from the terminal 30. In the embodiment, the host name given to the presentation apparatus 10 is “PC2”. The presentation apparatus 10 is one example of the claimed “information processing apparatus”.

The display 20 is a display that is disposed in the classroom 90. The display 20 includes a display unit that outputs video and a speaker that outputs audio. The display 20 is, for example, a cathode ray tube (CRT) display, a liquid crystal display (LCD), a plasma display panel (PDP), an electroluminescent (EL) panel, or an organic EL panel. To the display 20, video of the video file, which is played back by the presentation apparatus 10, is output through the video signal cable 50a and the audio signal cable 50b. The display 20 is one example of the claimed “output device”.

### Hardware Structure

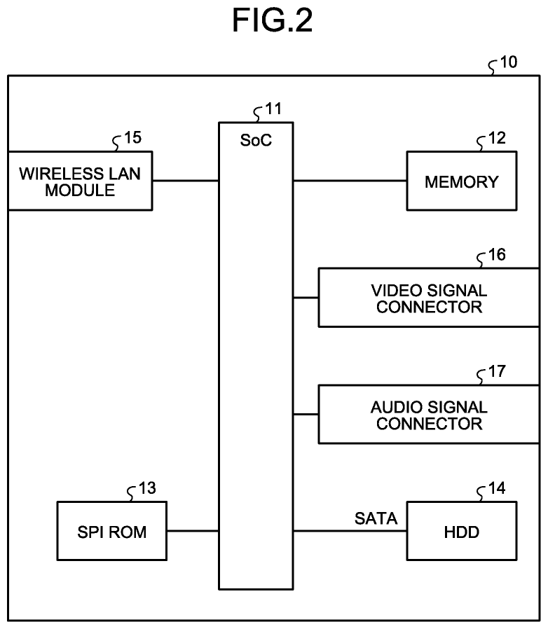

FIG. 2 is a diagram that illustrates one example of a hardware structure of the presentation apparatus 10. The presentation apparatus 10 includes a system-on-a-chip (SoC) 11, a memory 12, a serial peripheral interface read only memory (SPI ROM) 13, a hard disk drive (HDD) 14, a wireless LAN module 15, a video signal connector 16, and an audio signal connector 17. One example of the hardware structure of the presentation apparatus 10 will be explained with reference to FIG. 2.

The SoC 11 is, for example, a combination of a processor and an integrated circuit. In the presentation apparatus 10, the SoC 11 loads programs stored in the HDD 14 or the SPI ROM 13 to a work area of the memory 12 and executes the programs, so as to control a peripheral device. Thereby, the presentation apparatus 10 can perform a process that is suitable for a predetermined purpose. The memory 12, the HDD 14, and the SPI ROM 13 are recording media that can be read by the presentation apparatus 10.

The memory 12 and the SPI ROM 13 are each described as one example of a storage unit that is directly accessed by the SoC 11. For example, the memory 12 is a random access memory (RAM). The SPI ROM 13 is a ROM that is connected to the SoC 11 through a bus that is referred to as a Serial Peripheral Interface.

The HDD 14 stores various programs and various data in a recording medium in a manner that the programs and data can be read and written freely. For example, the HDD 14 is connected to the SoC 11 through a serial attached small computer system interface (SATA). The HDD 14 stores therein an operating system (OS), various programs, various tables, and the like. The OS includes a communication interface program that receives and transmits data from and to an external device that is connected through the wireless LAN module 15. The external device may be another information processing apparatus and an external storage device that are connected through a computer network or the like. The OS further provides to the programs an application programming interface (API) for setting the access right to the file.

The wireless LAN module 15 is a module that performs the wireless communication through the access point 40. The wireless LAN module 15 communicates with the external device by the wireless communication.

The video signal connector 16 is a connector to which the video signal cable 50a is connected. The SoC 11 outputs the video signal to the display 20 through the video signal cable 50a that is connected to the video signal connector 16. The audio signal connector 17 is a connector to which the audio signal cable 50b is connected. The SoC 11 outputs the audio signal to the display 20 through the audio signal cable 50b that is connected to the audio signal connector 17.

The presentation apparatus 10 may further include an input unit that receives an operation instruction or the like from a user. Examples of the input unit include an input device such as a keyboard, a pointing device, a touch panel, an acceleration sensor, and an audio input device.

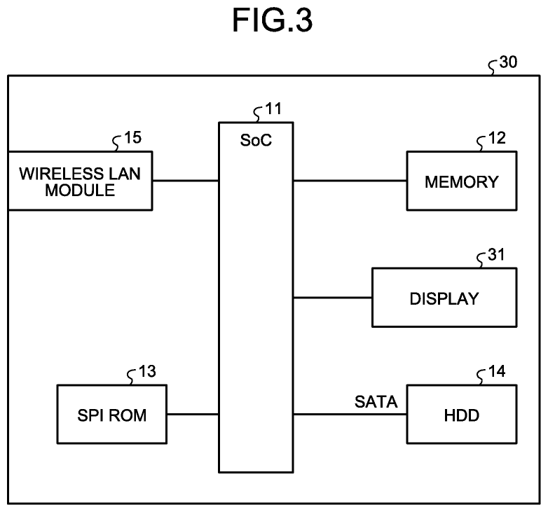

FIG. 3 is a diagram that illustrates one example of a hardware structure of the terminal 30. The terminal 30 includes the SoC 11, the memory 12, the SPI ROM 13, the HDD 14, the wireless LAN module 15, and a display 31. A component that is the same as the component in FIG. 2 is denoted by the same reference numeral, and the description thereof is omitted. One example of the hardware structure of the terminal 30 is hereinafter described with reference to FIG. 3.

The display 31 is a display that is included in the terminal 30. For example, to the display 31, a result of the information processing by the SoC 11 is output. Note that the HDD 14 of the terminal 30 stores therein the video file that includes the content of the class.

### Structure of Video File

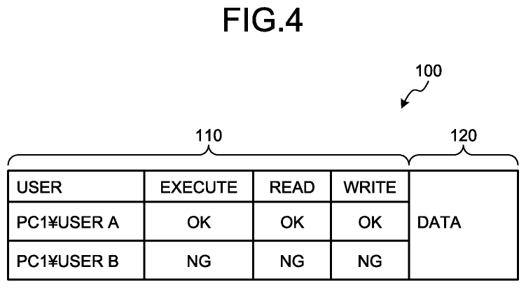

FIG. 4 is a diagram that illustrates one example of a structure of a video file 100. The video file 100 includes a table area 110 and a data area 120. One example of the structure of the video file 100 is hereinafter described with reference to FIG. 4.

Encoded video data is stored in the data area 120. Examples of an encoding scheme for encoding the video data include video experts group (MPEG)-2 and MPEG-4. The video file 100 is played back by, for example, a video playback application that is used for playing back the video file 100. The video file 100 and the video playback application are associated with each other by the OS. When the video file 100 is executed, the video playback application associated with the video file 100 is started. The started video playback application reads the video file 100 and performs a process of decoding the video data stored in the data area 120 to play back the video file 100.

In the table area 110, information representing the preset access rights are stored for each user account. The table area 110 includes items of “USER”, “EXECUTE”, “READ”, and “WRITE”. Information that specifies the user account is stored in “USER”. For example, the information that specifies the user account is a user account name. In the example in FIG. 4, “PC1¥user A” and “PC1¥user B” are stored as the user account name in “USER”. In the user account names, “PC1” represents a host name of the information processing apparatus whose user account is registered. As described above, “PC1” is the host name of the terminal 30. In the user account names, “user A” and “user B” each represent a user name. The sign “¥” is a delimiter that represents a border between the host name and the user name. For example, “PC1¥user A” represents a user account which is specified by the user name “user A” on the terminal 30 having the host name “PC1”. For “EXECUTE”, “READ”, and “WRITE”, flags representing the presence or absence of the access right are stored. The flag representing the presence or absence of an execution permission is stored in “EXECUTE”. The user account to which the execution permission is given is permitted to execute the file. The flag representing the presence or absence of a read permission is stored in “READ”. The user account to which the read permission is given is permitted to read the file. The flag representing the presence or absence of a write permission is stored in “WRITE”. The user account to which the write permission is given is permitted to edit and delete the file.

In the example in FIG. 4, the user account “PC1¥user A” has the execution permission, the read permission, and the write permission. On the other hand, the user account “PC1¥user B” has none of the execution permission, the read permission, and the write permission. As described above, the video file 100 is played back by that, the video file 100 is executed, and the video playback application, which is started by the execution of the video file 100, reads the video file 100. The video playback application is executed by the user account which has logged in to the presentation apparatus 10. Thus, when the user account, which has logged in to the presentation apparatus 10, has the execution permission and the read permission for the video file 100, the video playback application can play back the video file 100. If the user account “PC1¥user A”, which has the execution permission and the read permission for the video file 100, logs in to the presentation apparatus 10, the video playback application can play back the video file 100. On the other hand, if the user account “PC1¥user B”, which has no execution permission or read permission for the video file 100, logs in to the presentation apparatus 10, the video playback application cannot play back the video file 100. Note that user accounts, which are not registered in the table area 110, have none of the execution permission, the read permission, and the write permission. The video file 100 is one example of the claimed “video data”.

### Video Playback in Absence of Access Right

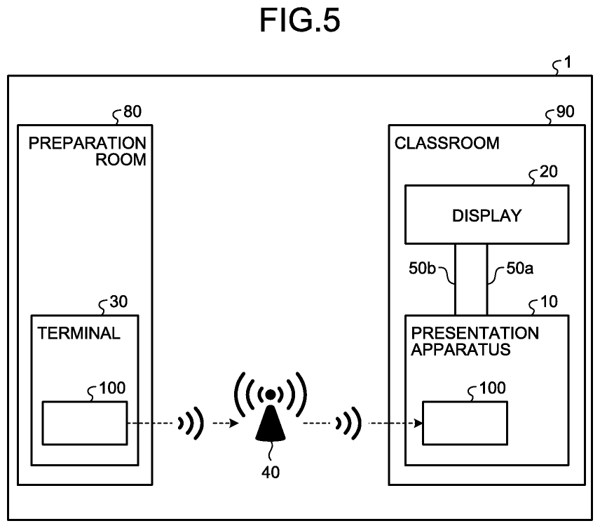

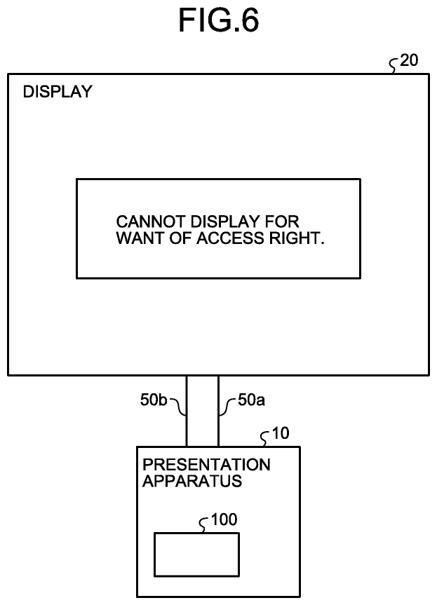

FIG. 5 is a diagram that illustrates one example of a scene where the video file 100 is transmitted from the terminal 30 to the presentation apparatus 10. In FIG. 5, the video file 100 stored in the terminal 30 is transmitted to the presentation apparatus 10 through the access point 40. The video file 100 stored in the presentation apparatus 10 includes the table area 110 storing settings of the access right. As illustrated in FIG. 4, the settings of the access right to the user account of the presentation apparatus 10 (PC2) is not stored in the table area 110. Thus, the user account of the presentation apparatus 10 has none of the execution permission, the read permission, and the write permission for the video file 100. As a result, even if the playback of the video is requested by the terminal 30, the video playback application, which is operated with the right of the user account logging in to the presentation apparatus 10, cannot play back the video file 100. FIG. 6 is a diagram that illustrates one example of a case where the video file 100 cannot be played back for want of the access right. In FIG. 6, the video file 100 cannot be played back because of want of the access right. Thus, in FIG. 6, the display 20 displays a message that says “cannot display for want of access right”.

### Process Flow at Start of Playback

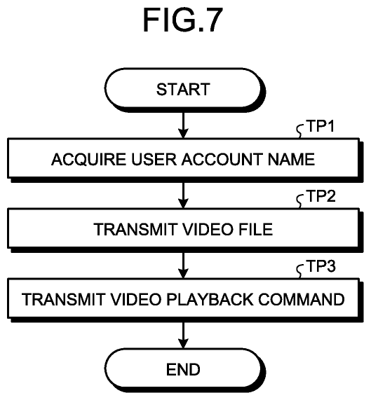

FIG. 7 is a diagram that illustrates one example of a process flow of a process in which the terminal 30 transmits the video file 100 to the presentation apparatus 10. A processing entity in FIG. 7 is the SoC 11 of the terminal 30. However, in the description, it is assumed that the processing entity is the terminal 30 for the convenience of description. One example of the process flow of the process in which the terminal 30 transmits the video file 100 to the presentation apparatus 10 is hereinafter described with reference to FIG. 7.

In TP1, the terminal 30 acquires a user account name of a user account which logs in to the terminal 30. The terminal 30 stores the acquired user account name in the HDD 14 provided in the terminal 30, for example. In TP2, the terminal 30 transmits, to the presentation apparatus 10, the video file 100 that is stored in the HDD 14 of the terminal 30. In TP3, the terminal 30 transmits, to the presentation apparatus 10, a video playback command for requesting to play back the video file 100. The video playback command includes the user account name acquired at TP1 and information that specifies the video file 100 transmitted at TP2. The information specifying the video file 100 is a file name of the video file 100, for example.

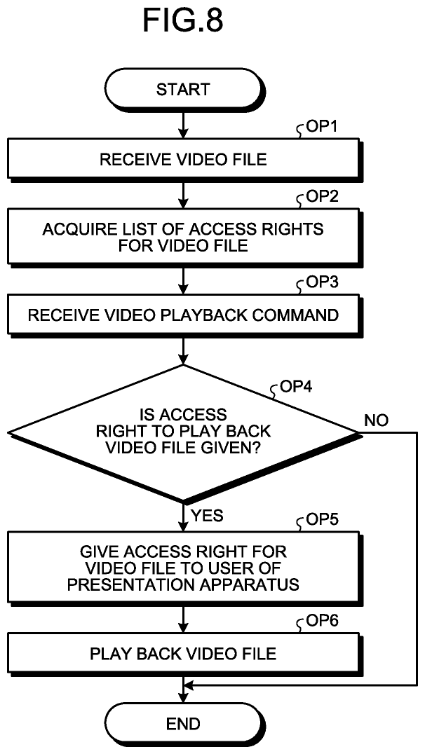

FIG. 8 is a diagram that illustrates one example of a process flow of a process in which the presentation apparatus 10 plays back the video file 100. In the process in FIG. 8, it is assumed that the user account which logs in to the presentation apparatus 10 is “PC2¥user C”. A processing entity in FIG. 8 is the SoC 11 of the presentation apparatus 10. However, in the description, it is assumed that the processing entity is the presentation apparatus 10 for the convenience of description. One example of the process flow of the process in which the presentation apparatus 10 plays back the video file 100 will be described with reference to FIG. 8.

In OP1, the presentation apparatus 10 receives the video file 100 from the terminal 30. The presentation apparatus 10 stores the received video file 100 in a predetermined directory of the HDD 14 provided in the presentation apparatus 10, for example. In OP2, the presentation apparatus 10 acquires a list of the access rights set in the video file 100 stored in the predetermined directory at OP1. The presentation apparatus 10 acquires the list of the access rights stored in the table area 110 of the video file 100 by using API that is provided by the OS. Examples of the API to acquire the list of the access rights include “icacl.exe” and “cacls.exe”. The presentation apparatus 10 stores, in the HDD 14 of the presentation apparatus 10, the acquired access right table containing the list of the access rights. The SoC 11 of the presentation apparatus 10 that performs the process in OP2 is one example of the claimed “permission unit”.

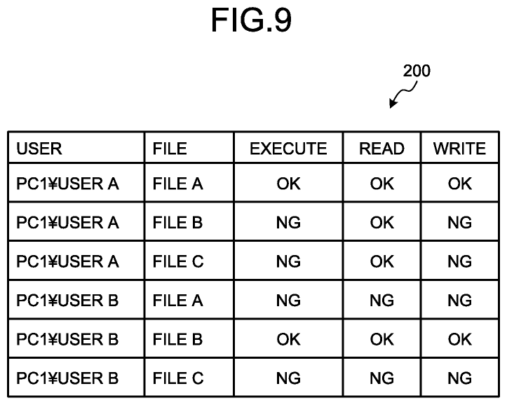

FIG. 9 is a diagram that illustrates one example of an access right table 200 that stores therein the list of the access rights. The access right table 200 includes items of “USER”, “FILE”, “EXECUTE”, “READ”, and “WRITE”. The items of “USER”, “EXECUTE”, “READ”, and “WRITE” are the same as those in FIG. 4, and description thereof is omitted. In “FILE”, file names of files, each for which the access right is prepared, is stored. In FIG. 9, “FILE” stores three types of file names: “FILE A”, “FILE B”, and “FILE C”. Thus, it can be seen that the access right table 200 illustrated in FIG. 9 stores therein the access rights for three video files 100. Referring to FIG. 9, it can be seen that the user account “PC1¥user A” has the execution permission, the read permission, and the write permission for the file whose file name is “FILE A”. In another example, with regard to the file whose file name is “FILE B”, it can be seen that the user account “PC1¥user A” has the read permission but does not have the execution permission and the write permission.

Referring back to FIG. 8, in OP3, the presentation apparatus 10 receives the video playback command from the terminal 30. As described above, the video playback command includes the user account name of the user account, which sent the video playback command, and the file name of the video file 100 that is a playback target. In the presentation apparatus 10 that has received the video playback command, the video playback application is started. The video playback application is executed with the right of the user account which has logged in to the presentation apparatus 10. Namely, the video playback application is executed with the right of the user account “PC2¥user C”. The video playback command is one example of the claimed “output request”. The user account name of the user account which has transmitted the video playback command is one example of the claimed “information that specifies a request source”. The SoC 11 of the presentation apparatus 10 that receives the video playback command is one example of the claimed “reception unit”.

In OP4, the presentation apparatus 10 extracts, from the received video playback command, the user account name and the file name of the video file 100 that is the playback target. The presentation apparatus 10 determines whether the user account, which is specified by the extracted user account name, has the access right to play back the video file 100 of the playback target. In the present embodiment described above, only the user account which has the execution permission and the read permission can play back the video file 100. Thus, in OP4, the presentation apparatus 10 performs the determination based on whether the execution permission and the read permission have been given. When the access right to play back the video file 100 of the playback target has been given (at OP4; YES), the process advances to OP5. When the access right to play back the video file 100 of the playback target has not been given (at OP4; NO), the process is terminated. The SoC 11 of the presentation apparatus 10 that performs the determination in OP4 is one example of the claimed “permission unit”.

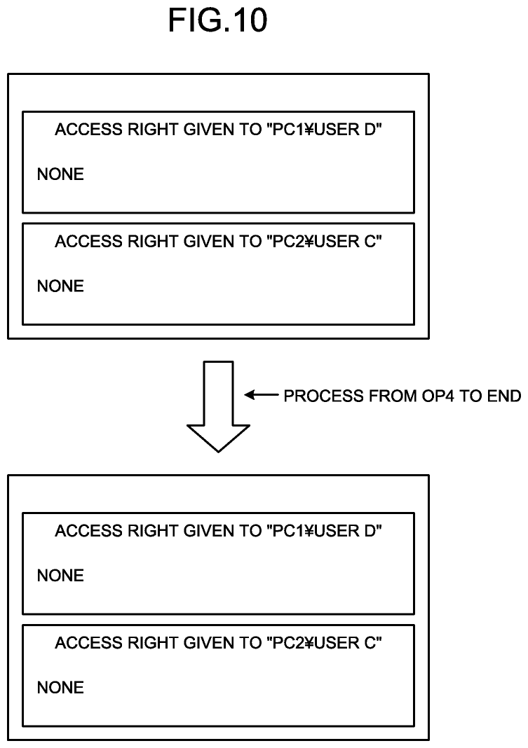

FIG. 10 is a diagram that illustrates one example of a transition of the access right to the video file 100 in a case where the process in OP4 in FIG. 8 is branched to NO. It is assumed here that the account name extracted at OP4 in FIG. 8 is “PC1¥user D”. In the example illustrated in FIG. 9, “PC1¥user D” is not registered in the access right table 200. Thus, the user account “PC1¥user D” has none of the execution permission, the read permission, and the write permission for the video file 100. Therefore, the access right to the video file 100 is not given to the user account “PC2¥user C” logging in to the terminal 30, either. As a result, the video playback application, which is operated with the right of the user account “PC2¥user C”, cannot play back the video file 100.

Referring back to FIG. 8, in OP5, the presentation apparatus 10 gives the access right to the video file 100 to the user account “PC2¥user C” which has logged in to the presentation apparatus 10. The access right to be given is the same as the one that has been given to the user account specified by the user account name extracted at OP3. The access right may be given in a manner that information about the access right to be given to the user account “PC2¥user C” is added to the table area 110 of the video file 100 by using the API provided by the OS. The SoC 11 of the presentation apparatus 10 that performs the process in OP5 is one example of the claimed “permission unit”.

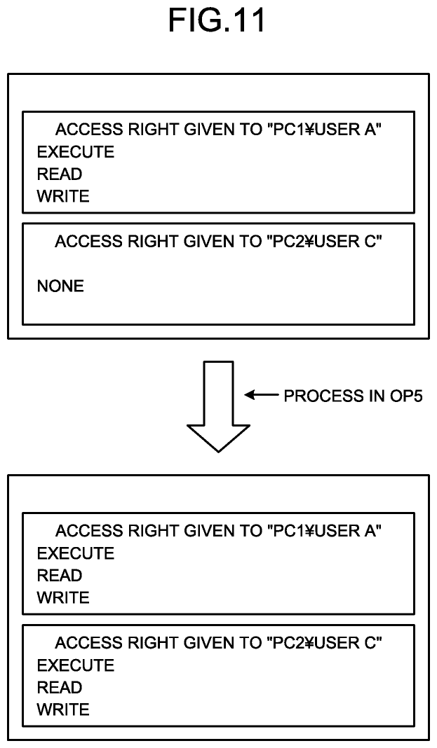

FIG. 11 is a diagram that illustrates one example of a transition of the access right to the video file 100 in the process in OP5 in FIG. 8. It is assumed here that the user account name extracted at OP4 in FIG. 8 is “PC1¥user A”. Referring to FIG. 11, before the process of OP5 in FIG. 8, the user account “PC2¥user C” which has logged in to the terminal 30 has none of the execution permission, the read permission, and the write permission. As a result of the process in OP5 in FIG. 8, it can be seen that the same access right as that of the user account “PC1¥user A” of the terminal 30 is given to the user account “PC2¥user C”. As a result, the user account “PC2¥user C” has the right to play back the video file 100.

Referring back to FIG. 8, in OP6, the video playback application can play back the video file 100 that is designated by the video playback command with the access right that is given in OP5. For example, the presentation apparatus 10 plays back the video file 100 by the video playback application that is operated with the authority of “PC2¥user C”. The played back video file 100 is output to the display 20.

### Process Flow at End of Playback

In the embodiment described above, the access right that is the same as that of the user account “PC1¥user A” is given to the user account “PC2¥user C”. The user account “PC2¥user C” is able to play back the video file 100 with the given access right. In the embodiment, a process of deleting the access right given to the user account “PC2¥user C” is performed when the playback ends.

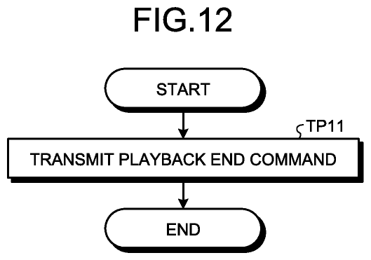

FIG. 12 is a diagram that illustrates one example of a process flow of the terminal 30 transmitting a playback end command. A processing entity in FIG. 12 is the SoC 11 of the terminal 30. However, in the description, it is assumed that the processing entity is the terminal 30 for the convenience of description. One example of the process flow of the terminal 30 transmitting the playback end command is hereinafter described with reference to FIG. 12.

In TP11, the terminal 30 transmits to the presentation apparatus 10, the playback end command to request to end the playback of the video. The playback end command includes information specifying the video file 100 that is a playback end target. The information specifying the video file 100 is the file name of the video file 100, for example.

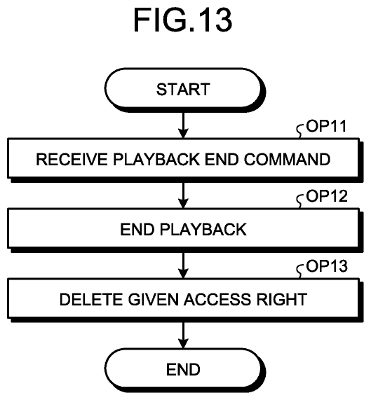

FIG. 13 is a diagram that illustrates one example of a process flow of a process in which the presentation apparatus 10 ends the playback of the video file 100. A processing entity in FIG. 13 is the SoC 11 of the presentation apparatus 10. However, in the description, it is assumed that the processing entity is the presentation apparatus 10 for the convenience of description. One example of the process flow of the process in which the presentation apparatus 10 ends the playback of the video file 100 is hereinafter described with reference to FIG. 13.

In OP11, the presentation apparatus 10 receives the playback end command from the terminal 30. The presentation apparatus 10 extracts the file name of the video file 100 as the playback end target from the playback end command. In OP12, the presentation apparatus 10 ends the playback of the video file 100 having the file name that is extracted at OP11. The end of the playback of the video file 100 is performed by ending the video playback application. The playback end command is one example of the claimed “end request”. The SoC 11 of the presentation apparatus 10 that performs the process in OP11 is one example of the claimed “reception unit”.

In OP13, the presentation apparatus 10 deletes the access right given to the user account “PC2¥user C” at OP5 in FIG. 8. The deletion of the access right is performed by deleting the information added at OP5 in FIG. 8 from the table area 110 of the video file 100 by using the API that is provided by the OS. The SoC 11 of the presentation apparatus 10 that performs the process in OP13 is one example of the claimed “permission unit”.

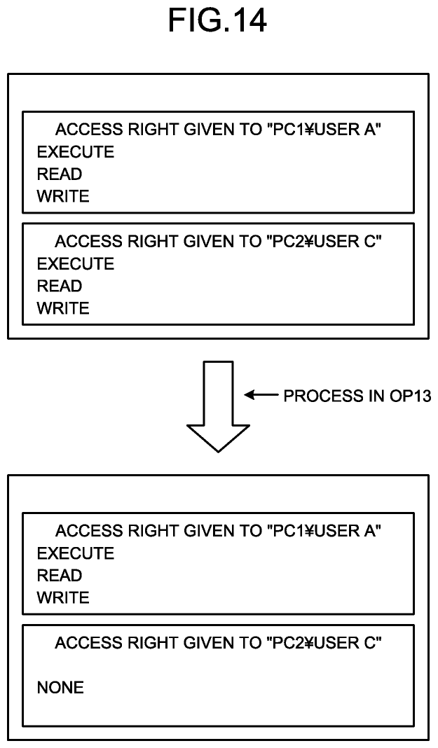

FIG. 14 is a diagram that illustrates one example of a transition of the access right to the video file 100 in the process in OP13 in FIG. 13. Referring to FIG. 14, before the process of OP13 in FIG. 13, the user account “PC2¥user C” logging in to the terminal 30 has the execution permission, the read permission, and the write permission. After the process in OP13 in FIG. 13, it can be seen that the execution permission, the read permission, and the write permission given to the user account “PC2¥user C” are deleted. As a result, the user account “PC2¥user C” loses the right to play back the video file 100 that was designated by the video playback command.

### Operation Advantage of Embodiment

In the embodiment, it is determined whether the user account “PC1¥user A”, which issued the video playback command, has the access right to play back the video file 100 (OP4 in FIG. 8). If the user account “PC1¥user A” has the access right to play back the video file 100 (OP4 in FIG. 8: YES), the access right that is the same as that of “PC1¥user A” is given to the user account “PC2¥user C” which has logged in to the terminal 30. Thus, in the embodiment, “PC2¥user C”, which originally does not have the right to play back the video file 100, can have the right to play back the video file 100. Therefore, in the embodiment, the presentation apparatus 10 can output the video file 100 to which this apparatus does not have the output right.

In the embodiment, when the user account “PC1¥user A” which issued the video playback command does not have the access right to play back the video file 100 (OP4 in FIG. 8: NO), the setting of the access right to “PC2¥user C” is not performed. Therefore, the embodiment can prevent the user account, which does not have the access right to play back the video file 100, from playing back the video file 100.

In the embodiment, the presentation apparatus 10 acquires the list of the access rights stored in the table area 110 of the video file 100, and stores the acquired list of the access rights in the access right table 200. The determination of whether the user account of the terminal 30 that has transmitted the video playback command has the access right to play back the video file 100 is performed by using the access right table 200. Thus, after the access right table 200 is created, even if the video playback command is further received, the presentation apparatus 10 can determine whether the access right is given by using the created access right table 200 without using the API provided by the OS. Therefore, in the embodiment, the presentation apparatus 10 can call the API of the OS less frequently. As a result, the presentation apparatus 10 can use less resource.

In the embodiment, the access right that has been given to “PC2¥user C” is deleted in the end of the playback of the video file 100 (FIG. 13). Thus, in the embodiment, when the playback of the video file 100 ends, the access right of “PC2¥user C” for the video file 100 can be returned to an original state. As a result, the deterioration in the security including the confidentiality of the video file 100 can be suppressed.

In the embodiment, the presentation apparatus 10 plays back the video file 100 that is stored in the HDD 14 of this device. Thus, the deterioration of the playback quality of the video due to the transmission delay can be suppressed as compared with the streaming in which the playback is performed while download is performed.

### Modifications

In the embodiment, the file output by the presentation apparatus 10 is exemplified by the video file 100. However, the file output by the presentation apparatus 10 is not limited to the video file 100. The file output by the presentation apparatus 10 may be, for example, an audio file that stores audio data. The file output by the presentation apparatus 10 may be a content including at least one of the video and the audio.

In the embodiment, the presentation apparatus 10 and the display 20 are connected by the video signal cable 50a and the audio signal cable 50b. However, the connection between the presentation apparatus 10 and the display 20 is not limited to the connection by the video signal cable 50a and the audio signal cable 50b. For example, the presentation apparatus 10 and the display 20 may be connected by a high-definition multimedia interface (HDMI (registered trademark)) cable that is capable of transmitting the video signal and the audio signal.

In the embodiment, the presentation apparatus 10 receives the video file 100 from the terminal 30 by the communication with the wireless LAN through the access point 40. However, the communication medium between the presentation apparatus 10 and the terminal 30 is not limited to the communication by the wireless LAN. The communication medium between the presentation apparatus 10 and the terminal 30 may be, for example, a wired LAN, a wide area network (WAN), a virtual private network (VPN), the Internet, or a telephone line of a mobile phone.

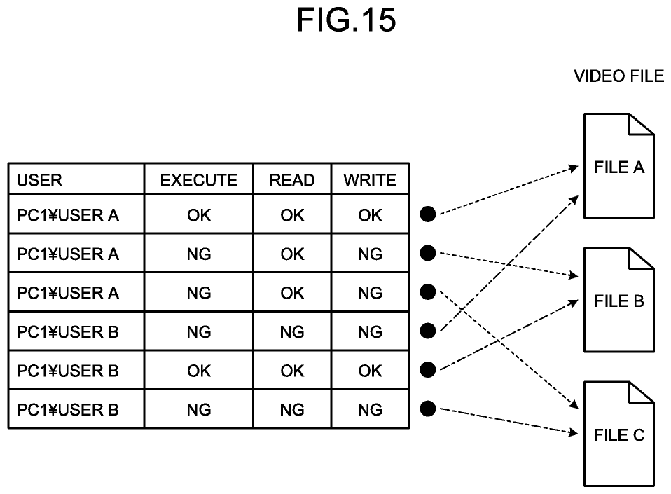

In the embodiment, the presentation apparatus 10 manages the access right to the video file 100 for each user account by using the access right table 200. In the access right table 200, the relation between the access right given to each user account and the video file 100 is represented by using the file name. However, the relation between the access right given to each user account and the video file 100 is not limited to using the file name. The relation between the set access right and the video file 100 may be represented by using a pointer that represents the location of the file, for example. FIG. 15 is a diagram that illustrates one example of the relation between the access right for each user account and the video file 100 using the pointer. In FIG. 15, for example, the video file 100 includes “FILE A”, “FILE B”, and “FILE C”. In FIG. 15, the pointer that correlates the access right with the video file 100 is illustrated with an arrow. A dotted line arrow represents a relation between the access right for the user account “PC1¥user A” and the video file 100. A dash-dotted line arrow represents a relation between the access right for the user account “PC1¥user B” and the video file 100. According to FIG. 15, it can be seen that the user account “PC1¥user B” has none of the execution permission, the read permission, and the write permission for “FILE C”.

In the embodiment, the HDD 14 is connected to the SoC 11 by the SATA. However, the HDD 14 may be connected thereto by a connection method other than the SATA. For example, the HDD 14 may be a storage area network (SAN) storage that is connected by a fiber channel.

The access right that is given to the user account in the embodiment is exemplified by the execution permission, the read permission, and the write permission. However, the access right given to the user account is not limited to the execution permission, the read permission, and the write permission. The access right given to the user account may be, for example, “full control”, “change”, “read and execute”, “read”, “write”, and “special access permission”. The access right given to the user account may employ the access right that is employed by the OS and a file system operating in the terminal 30 and the presentation apparatus 10.

In the embodiment, both the transmission of the video file 100 and the transmission of the video playback command are performed by the terminal 30. However, the transmission of the video file 100 and the transmission of the video playback command may be separately performed by different information processing apparatuses. For example, while the video file 100 may be transmitted to the presentation apparatus 10 from a file server that is different from the terminal 30, the video playback command may be transmitted from the terminal 30 to the presentation apparatus 10.

### Processor

Each process described above is performed by the SoC 11. However, each process described above may be performed by a processor other than the SoC 11, for example, a central processing unit (CPU), a microprocessor unit (MPU), or the like. The CPU is not limited to a single processor, and may have a multi-processor structure. Alternatively, a single CPU that is connected by a single socket may have a multi-core structure. At least some of the processes described above may be performed by a processor other than the CPU, for example, a dedicated processor such as a digital signal processor (DSP), a graphics processing unit (GPU), a numeric processor, a vector processor, or an image processor. Moreover, at least some of the processes described above may be performed by an integrated circuit (IC) or other digital circuit. Furthermore, at least some of the processes described above may be performed by an analog circuit. The integrated circuit includes an LSI, an application specific integrated circuit (ASIC), and a programmable logic device (PLD). For example, the PLD includes a field-programmable gate array (FPGA). Each process described above may be performed by a combination of the processor and the integrated circuit. This combination is referred to as, for example, a microcontroller (MCU), a system LSI, a chipset, or the like.

### Computer-Readable Recording Medium

A program that causes a computer or other machine or device (hereinafter, computer or the like) to perform any of the processes described above can be recorded in a recording medium of a computer program product, which is readable by the computer or the like. The process is achieved by causing the computer or the like to read and execute the program of the recording medium.

Note that the recording medium that can be read by the computer or the like is a recording medium in which information such as data and programs can be accumulated by electric, magnetic, optical, mechanical, or chemical action, and from which the information can be read by the computer or the like. Among the recording media, examples of the recording medium that is removable from the computer or the like include a flexible disk, a magneto-optical disc, a CD-ROM, a CD-R/W, a DVD, a Blu-ray disc, a digital audio tape (DAT), an 8-mm tape, and a memory card such as a flash memory. In addition, examples of the recording medium that is fixed to the computer or the like include a hard disk and a ROM.

The embodiment and modifications disclosed above can be combined with each other.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing apparatus comprising:
a memory; and
a processor that is connected to the memory and that:
receives, from another information processing apparatus, an output request of a file, wherein
the information processing apparatus has no output right with respect to the file, and
the output request includes information that specifies a request source of the output request; and
permits the information processing apparatus to output the file to an output device when the request source has the output right with respect to the file.

2. The information processing apparatus according to claim 1, wherein the processor further:
receives an end request to terminate the output of the file, and
cancels the permission to output the file to the output device when the end request is received.

3. The information processing apparatus according to claim 1, wherein the processor further sets, on a user account of the information processing apparatus, a right to output the file to the output device when the request source has the output right with respect to the file.

4. The information processing apparatus according to claim 1, wherein
the information that specifies the request source includes a user account from which the output request is sent, and
the processor further:
acquires information representing rights with respect to the file, wherein the rights are set for the user account, and
determines, based on the acquired information representing the rights, whether the user account has an output right with respect to the file.

5. The information processing apparatus according to claim 1, wherein
the file includes video data, and
the output device includes a display.

6. An information processing method implemented by a computer of an apparatus, the method comprising:
receiving, from another apparatus, an output request of a file, wherein
the apparatus has no output right with respect to the file, and
the output request includes information that specifies a request source of the output request; and
permitting the apparatus to output the file to an output device when the request source has the output right with respect to the file.

7. A computer program product comprising a non-transitory computer-readable recording medium that records an executable program, the program instructing a computer of an apparatus to execute:
receiving, from another apparatus, an output request of a file, wherein
the apparatus has no output right with respect to the file, and
the output request includes information that specifies a request source of the output request; and
permitting the apparatus to output the file to an output device when the request source has the output right with respect to the file.
